(19) United States
(12) Patent Application Publication
(10) Pub. No.: US 2003/0000357 A1
(43) Pub. Date: Jan. 2, 2003

(54) Method for forming cut lines in sheet

(76) Inventor: Yoshinori Tanaka, Kagawa (JP)

Correspondence Address: DARBY & DARBY P.C., P. O. BOX 5257, NEW YORK, NY, 10150-5257, US

(21) Appl. No.: 10/182,460

(22) PCT Filed: Jan. 12, 2001
(86) PCT No.: PCT/JP01/00163

(30) Foreign Application Priority Data
Jan. 26, 2000 (JP) 2000-017119

(51) Int. Cl. B26D 1/56

(52) U.S. Cl. 83/37; 83/346; 83/678

(57) ABSTRACT

There is disclosed a cut line forming method including: using a cutter roll (1) having cutting blades (2) protruded on its outer circumference and an anvil roll (10) for receiving the cutting blades; feeding a sheet (20) into the clearance between the cutter roll and the anvil roll; and turning the rolls individually to form cut lines (21) in the sheet. The cutting blades (2) of the cutter roll (10) are formed into a shape of letter “V”. The anvil roll has receiving faces (11) of a predetermined width (w) formed at an interval in a roll axis direction. The cutter roll (1) is turned to direct the crests of the V-shape of the cutting blades forward of the turning direction thereby to advance cuts from the side of the crests of the V-shape so that cut lines corresponding to the width size of the receiving faces may be intermittently formed in the sheet along the V-shape.

### BACKGROUND OF THE INVENTION

1. Field of the Invention

The present invention relates to a cut line forming method for forming a plurality of cut lines of a predetermined length in a sheet made of paper, a nonwoven fabric, a film, a composite of a nonwoven fabric and a film, a composite of a nonwoven fabric and a fibrous web, a composite of a film and a fibrous web, a composite of a film, a nonwoven fabric and a fibrous web, or the like.

2. Description if the Prior Art

In the general method for forming the cut lines of a predetermined length in those various sheets, both a cutter roll having a plurality of cutting blades protruded intermittently on the outer circumference for setting the length of the cut lines and an anvil roll having a receiving face for the cutting blades on the outer circumference are used and fed at the clearance inbetween with the sheet and are then turned. During these turns, the sheet is bitten and cut between the cutting blades and the receiving face so that the cut lines having the same length as that of the cutting blades are formed in a plurality of portions of the sheet. The term “cut line” as used herein is meant to indicate a slit, i.e., a long narrow cut which pass through the sheet.

In the cut line forming method of the prior art, however, the length of the edges of the cutting blades of the cutter roll (i.e., the linear length of the edges extending in a roll axis direction) is equalized to the length of the cut lines to be formed in the sheet, and the cutting blades are arrayed at an interval on the outer circumference of the cutter roll. With the edges thus being short, the individual cutting blades are weakened so that they are liable to be worn at their edges and to be folded or broken.

When intermittent cut lines, as arrayed obliquely with respect to the MD, are to be formed in a bulky sheet which is prepared by laying a layer of long fibers opened from TOW or a layer of split yarns over a base material sheet of a nonwoven fabric, for example, to have a basis weight of 50 g/m² or more, on the other hand, an offset force in a widthwise direction (CD) is applied to the layer of long fibers or split yarns by the cutting blades extending obliquely with respect to the circumferential direction of the cutter roll. As a result, there will arise a problem that the fiber layer is offset over the sheet.

As the cutter roll and the anvil roll are turned to form the cut lines, on the other hand, one cutting blade is pressed many times by the receiving face. As a result, the edges of the cutting blades are seriously worn. Moreover, the receiving face of the anvil roll is hit many times at the same portions by the cutting blades so that the receiving face is also seriously damaged or worn.

### SUMMARY OF THE INVENTION

An object of the invention is to provide a method for forming cut lines in a sheet, which is enabled to prevent the cutting blades from being worn, folded or broken, by making the length of the edges of the cutting blades (i.e., the linear length of the edges extending in the roll axis direction and/or in the roll circumference direction) larger than that of the cut lines.

Another object of the invention is to provide a cut line forming method which makes it hard for an offset force to act on the fibrous layer on the sheet by arranging the cut lines in a V-shaped array.

Still another object of the invention is to provide a cut line forming method which is enabled to elongate the life time of the edges of the cutting blades by shifting the portions of the edges to abut against the receiving faces.

According to a first aspect of the invention, there is provided a cut line forming method comprising: using a cutter roll having cutting blades protruded on its outer circumference and an anvil roll for receiving the cutting blades; feeding a sheet into the clearance between the cutter roll and the anvil roll; and turning the rolls individually to form cut lines in the sheet,

wherein the cutting blades of the cutter roll are formed into a shape of letter “V”, and the anvil roll has receiving faces of a predetermined width formed at an interval in a roll axis direction, and

wherein the cutter roll is turned to direct the crests of the V-shape of the cutting blades forward of the turning direction thereby to advance cuts from the side of the crests of the V-shape so that cut lines corresponding to the width size of the receiving faces may be intermittently formed in the sheet along the V-shape.

In the invention, the length of the edges of the cutting blades of the cutter roll (i.e., the length of the edges extending in the roll axis direction and/or in the roll circumference direction) is not reduced, but the receiving faces for receiving the cutting blades are made to have a predetermined width size, so that the cut lines of the length corresponding to the width size of the receiving faces can be formed when the sheet is pressed and cut by the cutting blades and the receiving faces. This makes it unnecessary to shorten the edges of the cutting blades so that the cutting blades can be less worn and can be prevented from being folded or broken.

In the invention, when the obliquely arrayed cut lines are to be formed in a bulky sheet which is prepared by laying a layer of long fibers opened from the TOW or a layer of split yarns over a base material of a nonwoven fabric or a film to have a basis weight of 50 g/m² or more and which is liable to be dispersed in the basis weight in the widthwise direction, for example, the cut lines are arrayed in the V-shaped pattern, and the abutting portions between the cutting blades and the receiving faces are advanced from the crests to the skirts of the V-shape. As the two rolls turn, therefore, substantially homogeneous forces act to the right and left in the widthwise direction (CD) upon the sheet at the layer of the long fibers or the layer of the split yarns across the crests of the V-shape. As a result, no extremely widthwise offset force will act on the layer of the long fibers or the like of the sheet so that the layer of the long fibers or the like is hardly offset or dispersed in the bulk.

Here, the V-shaped pattern of the cutting blades in the invention may be to have an acute angle or a rounded shape at the crest. As shown in FIG. 2A, moreover, the trailing end portion of the skirts of the V-shape of one cutting blade and the crest of the V-shape of another cutting blade preferably lie on a common line in the roll axis direction. With the crest of the V-shape being given the acute angle and laid on the common line, the pressure on the cutting blades can be easily made constant when the cutting blades abut against the receiving faces.

According to a second aspect of the invention, there is provided a cut line forming method comprising: using a cutter roll having cutting blades protruded on its outer circumference and an anvil roll for receiving the cutting blades; feeding a sheet into the clearance between the cutter roll and the anvil roll; and turning the rolls individually to form cut lines in the sheet,

wherein the anvil roll has receiving faces of a predetermined width formed at an interval in a roll axis direction,

wherein the receiving faces are formed to shift in the roll axis direction in accordance with the advance in the circumferential direction, so that the abutting portions of the cutting blades against the receiving faces may shift along the edges of the cutting blades at the next time when the cutting blades and the receiving faces abut against each other, and

wherein as the cutter roll and the anvil roll turn, the cut lines corresponding to the width size of the receiving faces are formed in the sheet and are arrayed at an interval in the extending direction of the receiving faces.

In this case, the receiving faces may be formed in a helical shape on the circumference of the anvil roll.

According to a third aspect of the invention, there is provided a cut line forming method comprising: using a cutter roll having cutting blades protruded on its outer circumference and an anvil roll for receiving the cutting blades; feeding a sheet into the clearance between the cutter roll and the anvil roll; and turning the rolls individually to form cut lines in the sheet,

wherein the anvil roll has receiving faces of a predetermined width formed at an interval in a roll axis direction,

wherein the cutting blades are formed to shift in the roll axis direction in accordance with the advance in the circumferential direction, so that the abutting portions of the cutting blades against the receiving faces may shift along the edges of the cutting blades at the next time when the cutting blades and the receiving faces abut against each other, and

wherein as the cutter roll and the anvil roll turn, the cut lines corresponding to the width size of the receiving faces are formed in the sheet and are arrayed at an interval in the extending direction of the cutting blades.

In this case, the cutting blades may be formed in a helical shape on the circumference of the cutter roll.

According to the second or third aspect of the invention, the receiving faces of the predetermined width shift in the roll axis direction as they extend in the circumferential direction of the anvil roll, or the cutting blades shift in the roll axis direction as they extend in the circumferential direction of the cutter roll. As a result, when the edges of the cutting blades extend continuously, for example, the abutting portions of the cutting blades against the receiving faces shift in the edge extending direction as the abutments are repeated. Therefore, the cutting blades can be prevented from abutting against the receiving faces exclusively at their identical portions, thereby to elongate the edge lifetime.

In the invention, the diametrical size of the cutter roll to the edges of the cutting blades is preferably made different from that of the receiving faces of the anvil roll.

With the cutter roll and the anvil roll being thus diametrically different, the cutting blades and the receiving faces can be prevented from abutting at their identical positions so that they can be less worn to elongate their lifetimes.

Moreover, the hardness of the receiving faces of the anvil roll is preferably lower than that of the cutting blades of the cutter roll.

In this case, while the cutting work is continued for a long time, the receiving faces are more easily worn or damaged than the cutting blades. However, the wear or damage of the receiving faces, as formed on the outer circumference of the anvil roll, can be easily remedied by the simple method of polishing the receiving faces while turning the anvil roll.

The sheet to be cut in the invention is, for example, made of paper, a nonwoven fabric, a film, a composite of a nonwoven fabric and a film, a composite of a nonwoven fabric and a fibrous web, a composite of a film and a fibrous web, or a composite of a film, a nonwoven fabric and a fibrous web. However, the invention should not be limited to the cutting of these sheets.

The invention is especially effective where the cut lines are to be formed in the sheet of which the fibrous web is a layer of long fibers such as fibers opened from TOW or split yarns so that it is bulky and is liable to be dispersed in the basis weight.

### BRIEF DESCRIPTION OF THE DRAWINGS

FIG. 1 is a perspective view showing a method for forming cut lines in a sheet according to a first embodiment of the invention;

FIG. 2A is a development of a cutter roll shown in FIG. 1, and FIG. 2B is a development of an anvil roll shown in FIG. 1;

FIG. 3 is a top plan view showing a cleaning sheet in which the cut lines are formed by the method shown in FIG. 1;

FIG. 4 is a section taken along line IV-IV of FIG. 3;

FIG. 5A is a development of a cutter roll in a second embodiment of the invention, and FIG. 5B is a development of an anvil roll in the second embodiment;

FIG. 6 is a top plan view showing a cleaning sheet in which the cut lines are formed by the cutter roll and the anvil roll shown in FIGS. 5A and 5B;

FIG. 7A is a development of a cutter roll in a third embodiment of the invention, and FIG. 7B is a development of an anvil roll in the third embodiment;

FIG. 8 is a top plan view showing a cleaning sheet in which the cut lines are formed by the cutter roll and the anvil roll shown in FIGS. 7A and 7B;

FIG. 9A is a development of a cutter roll in a fourth embodiment of the invention, and FIG. 9B is a development of an anvil roll in the fourth embodiment; and

FIG. 10 is a top plan view showing a sheet in which the cut lines are formed by the cutter roll and the anvil roll shown in FIGS. 9A and 9B.

### PREFERRED EMBODIMENTS OT THE INVENTION

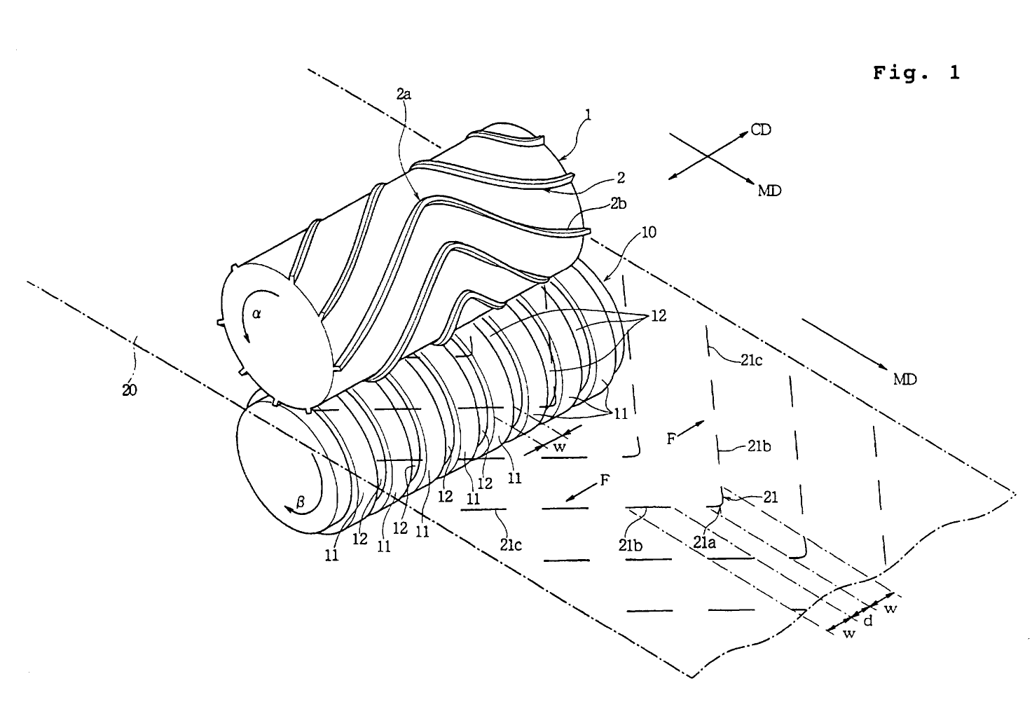

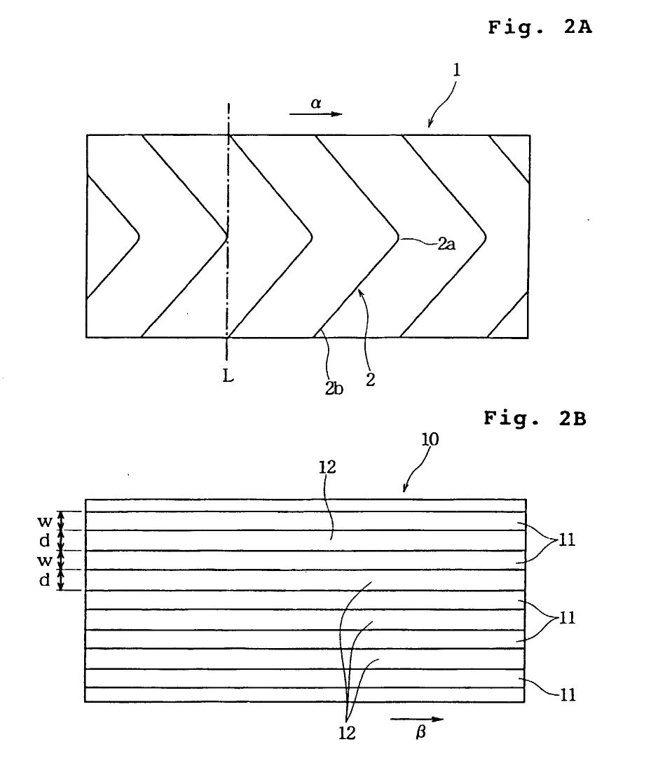

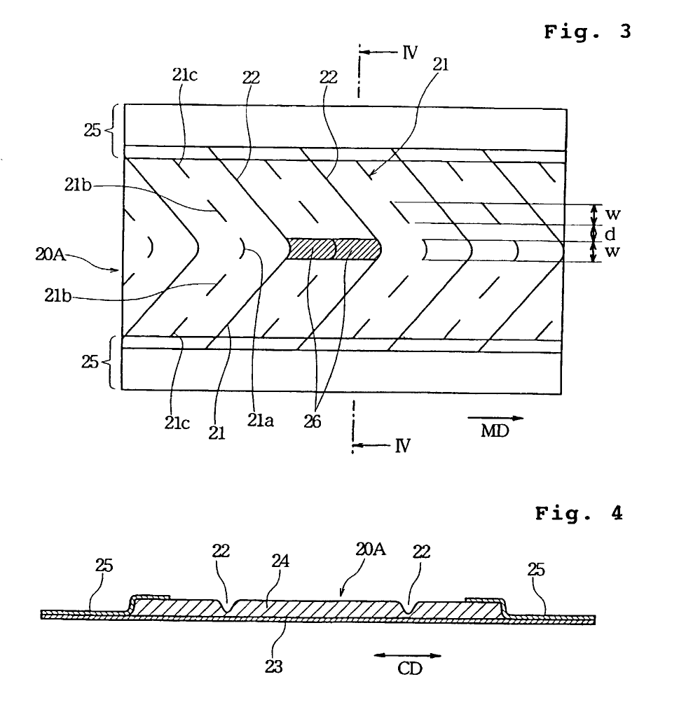

In FIGS. 1 to 4 showing a method for forming cut lines in a sheet according to a first embodiment of the invention: FIG. 1 is a perspective view showing the state in which a sheet is bitten between a cutter roll and an anvil roll; FIG. 2A is a development of the outer circumference of the cutter roll shown in FIG. 1; FIG. 2B is a development of the outer circumference of the anvil roll shown in FIG. 1; FIG. 3 is a top plan view of a cleaning sheet in which the cut lines are formed by that method; and FIG. 4 is a section taken along line IV-IV of FIG. 3.

FIG. 1 shows a cutter roll 1 and an anvil roll 10. The cutter roll 1 and the anvil roll 10 are made of cemented carbide or tool steel, for example. In this embodiment, a metallic material making the receiving faces 11 of the anvil roll 10 is less hard than that making the cutting blades 2 of the cutter roll 1.

As shown in FIG. 1, the cutter roll 1 is turned in the direction a whereas the anvil roll 10 is turned in the direction β. In this case, the turning force is preferably applied to at least the cutter roll 1. The anvil roll 10 may be given a turning force synchronized with the cutter roll 1 or may be set in a freely rotational state to follow the cutter roll 1.

A sheet 20 is bitten between the cutter roll 1 and the anvil roll 10 so that it is fed out in accordance with the turning directions of the individual rolls. In FIG. 1, letters MD designate the delivery direction of the sheet 20, and letters CD designate the width direction of the sheet 20 and the axial direction of the two rolls 1 and 10.

The cutter roll 1 is provided on its outer circumference with a plurality of cutting blades 2. These individual cutting blades 2 are protruded integrally from the outer circumference of the cutter roll 1. With the outer circumference of the cutter roll 1 being developed, as shown in FIG. 2A, the individual cutting blades 2 generally in the shape of letter “V” are arrayed at a constant interval in the turning direction and are formed continuously without any interruption in the roll axis direction (CD). It should be noted that the shape of the cutting blade as referred herein is meant to indicate a way in which the edge of the cutting blade is extended, when the outer circumference of the cutter roll is developed. Each cutting blade 2 is directed at its crest 2a of the V-shape forward (i.e., in the direction α) of the turning direction and at its open sides (or skirts) 2b of the V-shape backward of the direction a. In this embodiment, the crest 2a of the V-shape is rounded. However, the crest 2a is preferred to have an acute angle for keeping a contact pressure between the cutting blades 2 and the receiving faces 11 of the anvil roll 10 at a constant level. As shown in FIG. 2A, in addition, it is preferable that the end portions of the open sides 2b of any cutting blade 2 and the crest 2a of another cutting blade 2 line on a common line L extending in the roll axis direction. With this construction, it is possible to keep the contact pressure between the cutting blades 2 and the receiving faces 11 always at a constant level.

The anvil roll 10 is arranged in parallel with the cutter roll 1, and these anvil roll 10 and cutter roll 1 are elastically pushed by the not-shown elastic push means. The anvil roll 10 is provided on its outer circumference with the receiving faces 11 having a predetermined width size W. The receiving faces 11 are linearly extended in the turning direction of the anvil roll 10, as shown in the development of FIG. 2B, so that they are formed into the cylindrical faces which are extended to make one round in the turning direction of the anvil roll 10, as shown in FIG. 1. The individual receiving faces 11 are separated by grooves 12 so that they are spaced at a constant spacing d in the roll axis direction (CD) of the anvil roll 10.

The width size W of the receiving faces 11 in the roll axis direction is preferably 1 mm or more, and the spacing d of the receiving faces 11 in the roll axis direction is preferably 0.5 mm or more.

In the embodiment shown, the cutting blades 2, as formed on the cutter roll 1, are formed into the V-shape and continuously without any interruption in the roll axis direction of the cutter roll 1. However, it should be noted that the individual cutting blades 2 of the V-shape according to the invention may be interrupted at one or two or more portions midway of the roll axis direction. Accordingly, the term “V-shape” as used herein should not be construed to preclude such an uncontinuous V-shape which is interrupted midway. In this case, however, the extensions of the cutting blades 2 in the roll axis direction (CD) are required to be longer than the width size W of one receiving face 11 in the roll axis direction and to have a length sufficient for abutting against at least two adjoining receiving faces 11 when the two rolls 1 and 10 are turned.

As the sheet 20 is fed to the clearance between the cutter roll 1 and the anvil roll 10, it is delivered out in the MD by the turning forces of the cutter roll 1 in the direction a and the anvil roll 10 in the direction β.

In the construction shown in FIG. 1, the cutting blades 2 are continuous without any interruption in the roll axis direction of the cutter roll 1. In the anvil roll 10, on the other hand, the receiving faces 11 having the predetermined width W are formed at the spacing d in the roll axis direction. Therefore, the sheet 20 is cut only at portions where the cutting blades 2 and the receiving faces 11 abut. As a result, a plurality of cut lines 21 are cut in the sheet 20. The cut lines 21 are intermittently formed corresponding to the V-shape of the individual cutting blades 2. Hereinafter, the term “V-shaped cut lines” is meant to indicate a set of cut lines, which are intermittently formed corresponding to the V-shape of one cutting blade 2. The V-shaped cut lines 21 are arranged at the spacing d in the roll axis direction with such a width extending in the roll axis direction (CD) as is equalized to the width size W of the receiving faces 11.

The V-shaped cut lines 21 never fail to include one cut line forming the crest 21a of the V-shape. In other words, one of the receiving faces 11 of the anvil roll 10 is positioned to abut against the crests 2a of the V-shaped cutting blades 2. The remaining cut lines of the V-shaped cut lines 21 are intermittently arranged to form the slope portions 21b expanded backward of the MD from the crests 21a to the open end portions 21c of the V-shape.

In the embodiment shown in FIG. 1, the crests 2a of the V-shaped cutting blades 2 of the cutter roll 1 are directed forward (i.e., in the direction α) of the turning direction. In the sheet 20, therefore, the cut lines 21 are so extended that their cuts advance from the crests 21a to the open end portions 21c of the V-shape. When the slope portions 21b of the cut lines 21 are to be formed, forces F outward of the width direction (CD) are caused to act on the sheet 20 by the slope portions of the cutting blades 2 extending obliquely. However, these forces F act substantially homogeneously to the right and left or outward of the widthwise direction across the crests 21a of the V-shape so that neither any offset force nor any widthwise centralized force acts on the sheet 20. What acts on the sheet 20 is the widthwise tensions which are caused by the forces F and F directed homogeneously to the right and left. Therefore, the sheet 20 is cut without any deformation by the cutting blades 2 and the receiving faces 11 so that the cut lines 21 are regularly formed without any distortion or any displacement.

Especially where the sheet 20 has the following construction, the homogeneous forces F and F are applied to eliminate the offset or concentration of a fibrous web 24 on the sheet 20. In this construction, for example, the sheet 20 is manufactured by laying the fibrous web 24, as made of long fibers such as fibers opened from TOW or split yarns, over a base material of nonwoven fabric 23, film or a composite of the nonwoven fabric and the film, as shown in FIG. 4, so that it is bulky to have a basis weight of 50 g/m² or more but is liable to vary in the basis weight.

In this embodiment, moreover, the diameter of a virtual cylinder containing the edges of the cutting blades 2 of the cutter roll 1 is different from that of the receiving faces 11 of the anvil roll 10. Therefore, the cutting blades 2 abut less repeatedly against the same portions of the confronting receiving faces 11 so that they abut against different portions of the receiving faces 11 when the cutter roll 1 is turned. As a result, the receiving faces 11 are hardly worn or damaged at their local portions.

On the other hand, the receiving faces 11 of the anvil roll 10 are made of a less hard material than that of the cutting blades 2 of the cutter roll 1 so that the receiving faces 11 are worn before the cutting blades 2 after the cutting actions are repeated for a long time. This makes it possible to delay the progress of the wear of the cutting blades 2. The wear or damage on the surfaces of the receiving faces 11 can be remedied at a simple step by turning the anvil roll 10 to grind the surfaces of the receiving faces 11.

FIG. 3 is a top plan view showing a cleaning sheet 20A as an example of the sheet 20, in which the cut lines 21 are formed by the method shown in FIG. 1, and FIG. 4 is a section taken along line IV-IV of FIG. 3.

This cleaning sheet 20A is manufactured by laying the fibrous web 24 over the base material or the nonwoven fabric 23. The nonwoven fabric 23 is exemplified by spun-bonded, thermal bonded, or spun-lace nonwoven fabric containing fusible fibers such as those of PET, PE or PP or their composite fibers. Alternatively, the base material may be exemplified either by a fusible film in place of the nonwoven fabric 23 or by a laminate of the nonwoven fabric 23 and the film.

The fibrous web 24 is a fibrous layer made of long fibers such as fibers opened from the TOW or split yarns. These fibers are extended mainly in the delivery direction (MD) of the sheet 20A. The long fibers such as fibers opened from the TOW or split yarns may be extended as long as the entire length of the cleaning sheet 20A in the MD, or the fibrous web 24 may be formed of bundles of fibers shorter than the entire length in the MD. The fibers making the fibrous web 24 also contain the fusible fibers such as those of PET, PE or PP or their composite fibers.

On the two side portions of the cleaning sheet 20A lying opposite one another in the widthwise direction (CD), there are disposed holding sheets 25 and 25. These holding sheets 25 and 25 are made of a sheet similar to the nonwoven fabric 23. The nonwoven fabric 23 and the holding sheets 25 and 25 sandwich the two side portions of the fibrous web 24 and are adhered with a hot-melt adhesive or fused to each other.

In this cleaning sheet 20A, there are formed fused lines 22. The individual fused lines 22 are continuously extended in a shape of letter “V”, which is identical to the V-shape along which the cut lines 21 are arranged. By these fused lines 22, the nonwoven fabric 23 and the fibrous web 24 are pressed and fused to each other. These fused lines 22 are formed by feeding the sheet to the clearance between a heating roll having a V-shaped pressure portion on the surface and a receiving roll confronting the heating roll.

When the cleaning sheet 20A thus having the fused lines 22 is fed into the clearance between the cutter roll 1 and the anvil roll 10, as shown in FIG. 1, the V-shaped cut lines 21 are formed between the fused lines 22 and 22. The nonwoven fabric 23 and the fibrous web 24 are cut together along those cut lines 21.

If necessary, moreover, the fibers composing the fibrous web 24 are napped. In hatched regions 26 in FIG. 3, therefore, the fibers forming the fibrous web 24 are held by the fused lines 22 but released at the portion of the cut line 21. As a result, the cut fibers extending from the fused lines 22 to the cut line 21 form a brush-shaped portion. Such brush-shaped portions of the fibrous layer are formed in all the regions that are defined by the fused lines 22 and the cut lines 21.

In this cleaning sheet 20A, the brush-shaped portions can wipe off dust or the like. In the remaining regions lacking the cut lines 21, the fibrous layer extends in a bridge shape between the fused lines 22 and 22 adjoining in the MD so that it can trap the dust or relatively large pieces of trash between the fibers.

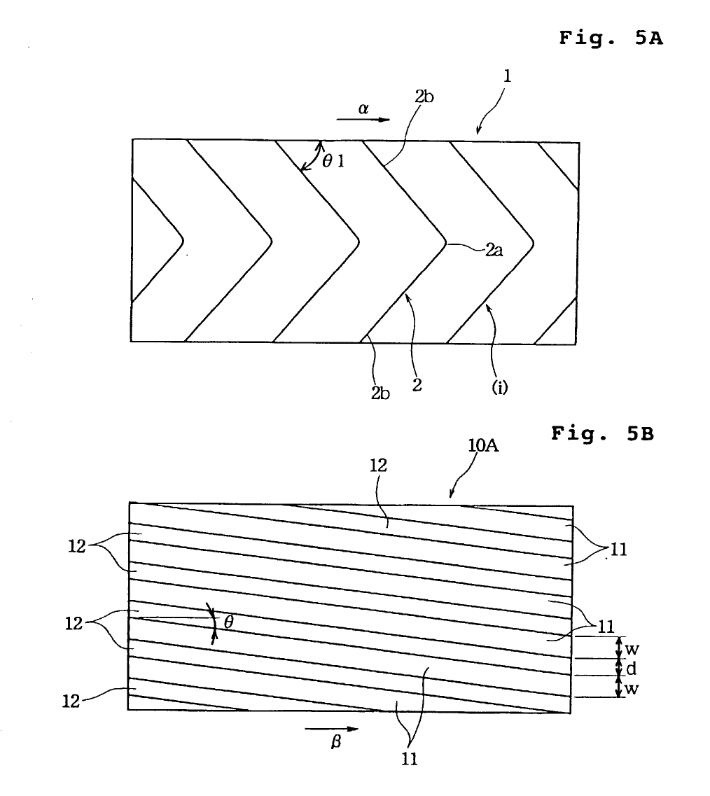

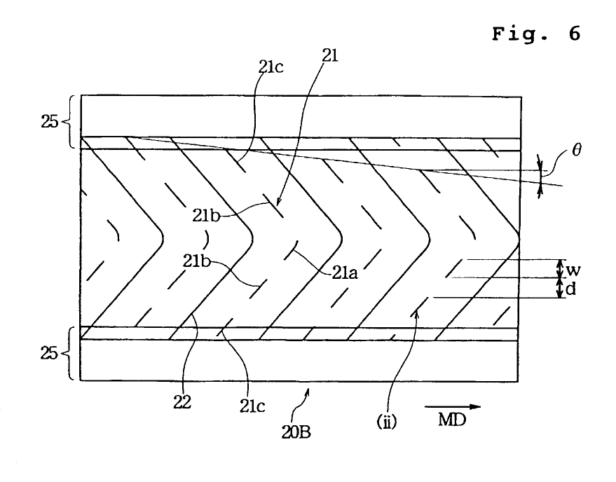

Of FIGS. 5A and 5B and FIG. 6 showing a second embodiment of a method according to the invention for forming cut lines: FIG. 5A is a development of the outer circumference of the cutter roll 1; FIG. 5B is a development of the outer circumference of an anvil roll 10A; and FIG. 6 is a top plan view showing a sheet 20B having cut lines.

The cutter roll 1 shown in FIG. 5A is identical to the cutter roll 1 shown in FIG. 2A to have the generally V-shaped cutting blades 2 formed at the constant interval in the turning direction (or in the direction a). The individual cutting blades 2 are formed continuously without any interruption in the roll axis direction (CD).

On the outer circumference of the anvil roll 10A shown in FIG. 5B, there are formed the receiving faces 11 of the predetermined width W and the grooves 12 for separating the receiving faces 11 at the spacing d in the roll axis direction. The width size W of the receiving faces 11 in the roll axis direction (CD) is preferably 1 mm or more, and the spacing d of the receiving faces 11 in the roll axis direction (CD) is preferably 0.5 mm or more.

However, the receiving faces 11 are so formed at an angle of inclination θ with respect to the circumferential direction that they may shift in the roll axis direction (CD) as they go in the circumferential direction (or in the turning direction, i.e., the direction β). In the anvil roll 10A, more specifically, the receiving faces 11 of the predetermined width W are formed helical in the roll axis direction.

The inclination angle θ is not especially limited if it exceeds 0 degrees. If this angle θ is so set that the receiving faces 11 are displaced by W+d in the roll axis direction when the anvil roll 10A makes one turn, however, they form one helical line continuing in the circumferential direction of the anvil roll 10A. Here, the receiving faces 11 may form two or more helical lines continuing in the circumferential direction of the anvil roll.

If the cutting blades 2 of the cutter roll 1 are inclined at an angle θ1 with respect to the roll circumference direction, on the other hand, the angle θ is preferably (½)·θ1 or less.

FIG. 6 shows the sheet which is fed to the clearance between the cutter roll 1 and the anvil roll 10A, as shown in FIGS. 5A and 5B, to form the cut lines 21. This sheet shown in FIG. 6 is the cleaning sheet 20B, which has the same structure as that of the cleaning sheet 20A shown in FIGS. 3 and 4. In the cleaning sheet 20B shown in FIG. 6, the fused lines 22 are formed as in the cleaning sheet 20A shown in FIG. 3, and the cut lines 21 are formed between the fused lines 22.

In the embodiment shown in FIGS. 5A and 5B and FIG. 6, the receiving faces 11 of the anvil roll 10A are formed helically in the roll axis direction, so that the cut lines 21 formed in the cleaning sheet 20B are formed to have a length corresponding to the width size W in the roll axis direction (CD) of the receiving faces 11 and are arrayed to have the angle θ with respect to the MD in accordance with the extending direction of the receiving faces 11.

In the embodiment shown in FIGS. 5A and 5B and FIG. 6, the receiving faces 11 of the anvil roll 10A are helically formed. Therefore, the portions of the edges of the cutting blades 2 to abut against the receiving faces 11 shift along the edges of the cutting blades 2 in accordance with the turns. For example, when the predetermined cutting blade 2, as indicated at (i) in FIG. 5A, abuts against the receiving face 11 of the anvil roll 10A, the cut line 21 is formed, as indicated at (ii) in FIG. 6. After this, when the cutter roll 1 and the anvil roll 10A turn so that the cutting blade 2 at (i) abuts against the receiving face 11 once again, the abutting portion of the cutting blade 2 at (i) against the receiving face 11 shifts in the roll axis direction (CD) along the edge of the cutting blade 2.

For this action, it is necessary that the diameter of the virtual cylinder containing the edges of the cutter roll 1 be different from the diameter of the receiving faces 11 of the anvil roll 10A. With this diametrical difference, the portion of the receiving face 11 to receive the cutting blade 2 at (i) shifts in the circumferential direction as the turns of the rolls advance. The receiving faces 11 are inclined to shift in the roll axis direction as they move in the circumferential direction of the anvil roll 10A. Therefore, the abutting portion of the cutting blade 2 at (i) against the receiving face 11 shifts in the roll axis direction along the edge of the cutting blade 2 in accordance with the inclination (θ) of the receiving faces 11.

With the receiving faces 11 being inclined with respect to the circumferential direction and with the two rolls being given the different diameters, the abutting portions of the cutting blades 2 against the receiving faces 11 shift along the edges of the cutting blades 2 as the rolls turn, and the cutting blades 2 do not abut the same portions of the receiving faces 11. Therefore, both the cutting blades 2 and the receiving faces 11 are neither worn nor damaged locally at the same portions.

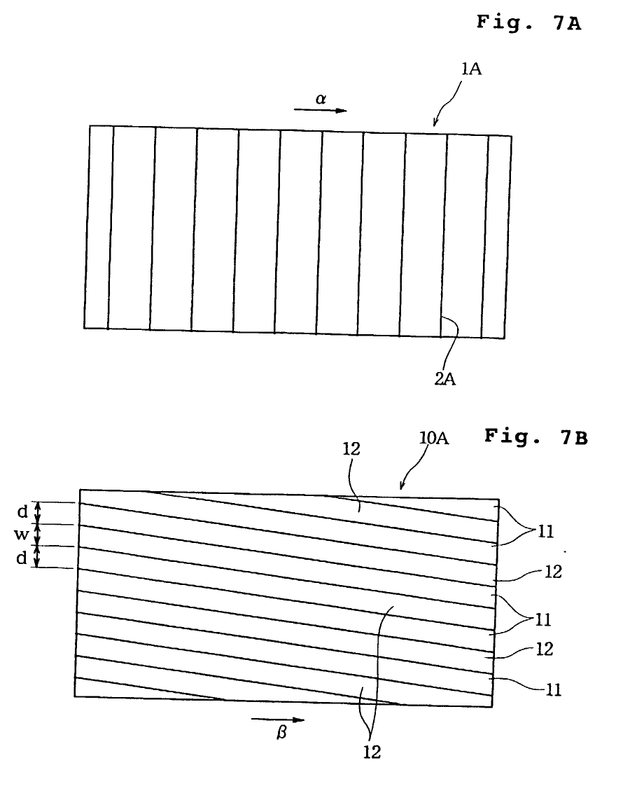

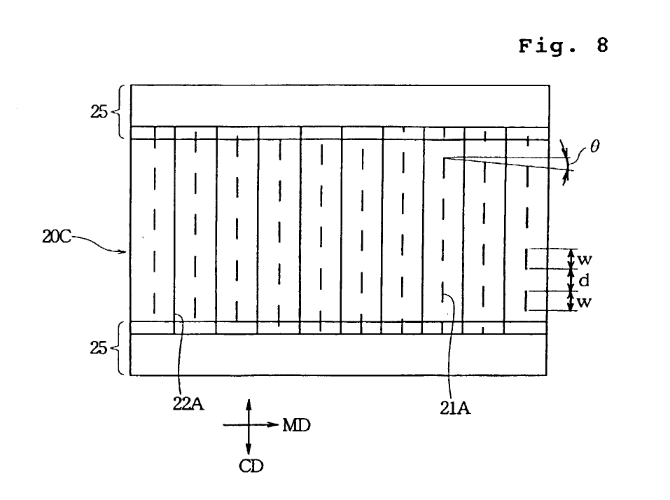

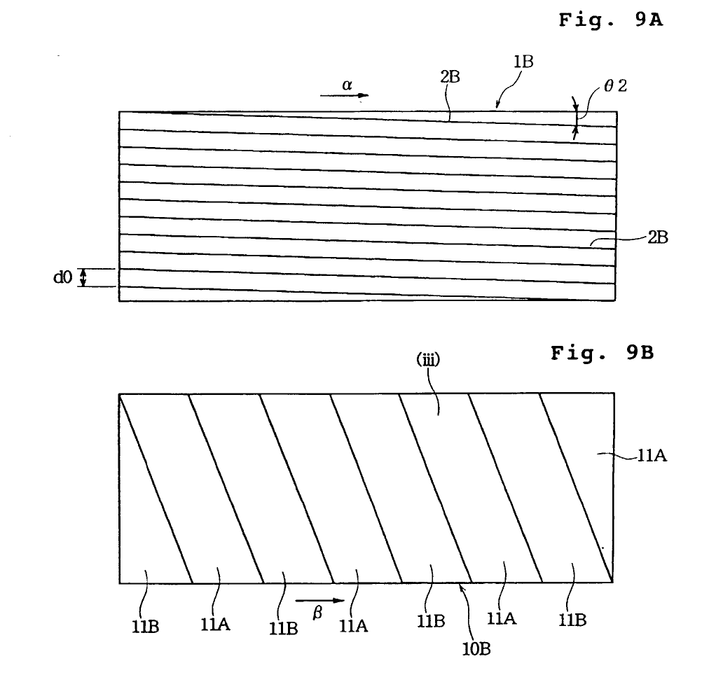

FIGS. 7A and 7B and FIG. 8 show a third embodiment of the invention. The anvil roll 10A shown in FIG. 7B is identical to that shown in FIG. 5B. In a cutter roll 1A shown in FIG. 7A, however, cutting blades 2A, as protruded from the outer circumference, are extended at a right angle with respect to the turning direction (or the direction a) and linearly in the roll axis direction (CD).

In a cleaning sheet 20C, as shown in FIG. 8, cut lines 21A are formed by the cutter roll 1A and the anvil roll 10A, as shown in FIGS. 7A and 7B. The cleaning sheet 20C shown in FIG. 8 is given a layer structure identical to those shown in FIGS. 3, 4 and 6 by laminating the nonwoven fabric 23 and the fibrous web 24. In the cleaning sheet 20C shown in FIG. 8, a set of cut lines 21A are formed by one cutting blade 2A to extend linearly in the widthwise direction (CD) like a perforated line. Between these sets of the cut lines 21A, there are interposed fused lines 22A extending linearly in the CD to bond the nonwoven fabric and the fibrous web.

The diameter of the virtual cylinder containing the edges of the cutting blades 2A of the cutter roll 1A, as shown in FIG. 7A, is made different from the diameter of the receiving faces 11 of the anvil roll 10A, as shown in FIG. 7B, and the receiving faces 11 are inclined helically at the angle θ with respect to the turning direction. As the two rolls 1A and 10A turn, therefore, the abutting portions of the cutting blades 2A against the receiving faces 11 shift in the roll axis direction along the edges of the cutting blades 2A, and the abutting portions of the receiving faces 11 against the cutting blades 2A also shift. Like the embodiment shown in FIGS. 5A and 5B and FIG. 6, therefore, the cutting blades 2A and the receiving faces 11 can be prevented from being locally worn and damaged.

In the cleaning sheet 20C shown in FIG. 8, the cut lines 21A are arrayed at a spacing in the direction which is inclined at the angle θ with respect to the MD, i.e., in accordance with the extending direction of the receiving faces 11. In the regions defined between the fused lines 22A and the cut lines 21A, moreover, the fibers cut by the cut lines 21A are raised from the nonwoven fabric 23 while having their root ends at the fused lines 22A, to form the napped brush-shaped portions. In the regions having no cut line 21A, on the other hand, the fibrous layer extends in a bridge shape between the fused lines 22A and 22A.

Here, the sheet in the invention should not be limited to the composite one of the nonwoven fabric 23 and the fibrous web 24, as shown in FIG. 4, but may be a composite sheet of nonwoven fabrics, a composite sheet of a film and a fibrous web or a film and a nonwoven fabric, a composite sheet of a film, a nonwoven fabric and a fibrous web, or a single layer sheet of a nonwoven fabric, a film or paper.

It should be noted that the purpose of forming the cut lines intermittently is not limited to the napping of the fibers as in the aforementioned cleaning sheet to form the brush-shaped portion. The cut lines may be used for another application such as perforated lines for opening envelopes or cut lines for making a film air-permeable.

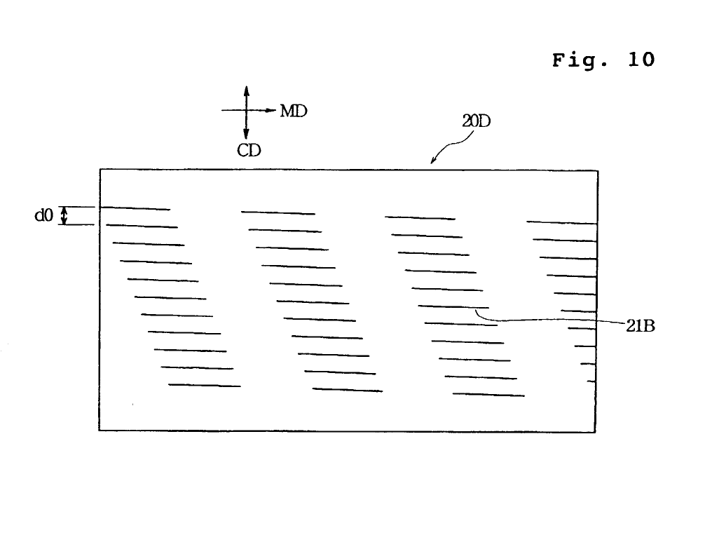

A fourth embodiment to be used for forming the cut lines for such applications is shown in FIGS. 9A and 9B and FIG. 10. FIG. 9A is a development of a cutter roll 1B; FIG. 9B is a development of an anvil roll 10B; and FIG. 10 is a top plan view of a sheet 20D in which cut lines 21B are formed by the cutter roll 1B and the anvil roll 10B shown in FIGS. 9A and 9B.

In the cutter roll 1B shown in FIG. 9A, cutting blades 2B are extended in the circumferential direction but at an inclination of angle θ₂ with respect to the circumferential direction. These cutting blades 2B have a spacing d0 in the roll axis direction. The cutting blades 2B form one helical line on the outer circumference of the cutter roll 1B if the angle θ2 is so set that the cutting blades 2B shift by the spacing d0 in the roll axis direction when the cutter roll 1B makes one turn.

In the anvil roll 10B shown in FIG. 9B, receiving faces 11A and grooves 11B are formed alternately in the circumferential direction. In FIG. 9B, the receiving faces 11A and the grooves 11B are formed at an inclination with respect to the roll axis direction but may be extended in parallel in the roll axis direction.

The cutter roll 1B and the anvil roll 10B are fed inbetween with the sheet 20D and are turned. Then, the sheet 20D is cut at the portions where the cutting blades 2B and the receiving faces 11A abut against each other. As a result, the plurality of cut lines 21B are formed in the sheet 20D. These cut lines 21B are arranged at the spacing d0 in the roll axis direction in accordance with the extending direction of the receiving faces 11A and are spaced in accordance with the extending direction of the edges of the cutting blades 2B.

In this embodiment, the abutting portions of the cutting blades 2B against the receiving faces 11A shift sequentially in the extending direction of the edges of the cutting blades 2B as the two rolls turn. Especially with the two rolls having the different diameters, if the receiving face 11A indicated at (iii) abuts against the cutting blade 2B at one turn, when the receiving face 1A at (iii) abuts against the cutting blade 2B once again at next turn, the abutting portion of the cutting blade 2B against the receiving face 11A at (iii) shifts in the extending direction of the edge of the cutting blade 2B. Therefore, the cutting blades 2B can be prevented as much as possible from being locally worn.

The sheet 20D shown in FIG. 10 may be exemplified by a sheet manufactured by laying a bulky nonwoven fabric over a base material of a nonwoven fabric or a film. With the cut lines 21B being formed, the sheet 20D is suited for a cleaning sheet because the dust or refuse can be easily trapped at the cut lines 21B between the base material and the nonwoven fabric.

As has been described hereinbefore, according to the invention, the length of the cut lines is determined by the width size W of the receiving faces of the anvil roll so that the cutting blades of the cutter roll can be made longer than the cut lines. This makes it unnecessary unlike the prior art to provide the cutting blades having the short edges and makes it possible to elongate the lifetime of the cutting blades and to prevent the cutting blades from any damage or from being folded or broken.

When the cut lines are formed in the V-shaped array, no offset force is applied to the sheet so that the V-shaped cut lines can be regularly formed without any distortion or displacement.

When the receiving faces are extended obliquely with respect to the circumferential direction of the anvil roll, moreover, the abutting portions of the cutting blades against the receiving faces can be shifted along the edges of the cutting blades to prevent the cutting blades from being locally worn or damaged.

According to the invention, still moreover, the rolls can be given the simple structures and can be easily polished to lower the production cost and to shorten the manufacture period.

Here, “comprises/comprising” when used in this specification is taken to specify the presence of stated features, integers, steps or components but does not preclude the presence or addition of one or more other features, integers, steps, components or groups thereof.

Although various exemplary embodiments have been shown and described, the invention is not limited to the embodiments shown. Therefore, the scope of the invention is intended to be limited solely by the scope of the claims that follow.

1. A cut line forming method comprising: using a cutter roll having cutting blades protruded on its outer circumference and an anvil roll for receiving said cutting blades; feeding a sheet into the clearance between said cutter roll and said anvil roll; and turning said rolls individually to form cut lines in said sheet,
wherein the cutting blades of said cutter roll are formed into a shape of letter “V”, and said anvil roll has receiving faces of a predetermined width formed at an interval in a roll axis direction, and
wherein said cutter roll is turned to direct the crests of the V-shape of said cutting blades forward of the turning direction thereby to advance cuts from the side of said crests of the V-shape so that cut lines corresponding to the width size of said receiving faces may be intermittently formed in said sheet along said V-shape.

2. The cut line forming method as set forth in claim 1,
wherein the diametrical size of said cutter roll to the edges of said cutting blades is made different from that of the receiving faces of said anvil roll.

3. The cut line forming method as set forth in claim 1,
wherein the hardness of the receiving faces of said anvil roll is lower than that of the cutting blades of said cutter roll.

4. The cut line forming method as set forth in claim 1,
wherein said sheet is made of paper, a nonwoven fabric, a film, a composite of a nonwoven fabric and a film, a composite of a nonwoven fabric and a fibrous web, a composite of a film and a fibrous web, or a composite of a film, a nonwoven fabric and a fibrous web.

5. The cut line forming method as set forth in claim 4,
wherein said fibrous web is a layer of long fibers.

6. A cut line forming method comprising: using a cutter roll having cutting blades protruded on its outer circumference and an anvil roll for receiving said cutting blades; feeding a sheet into the clearance between said cutter roll and said anvil roll; and turning said rolls individually to form cut lines in said sheet,
wherein said anvil roll has receiving faces of a predetermined width formed at an interval in a roll axis direction,
wherein said receiving faces are formed to shift in said roll axis direction in accordance with the advance in the circumferential direction, so that the abutting portions of said cutting blades against said receiving faces may shift along the edges of said cutting blades at the next time when said cutting blades and said receiving faces abut against each other, and
wherein as said cutter roll and said anvil roll turn, the cut lines corresponding to the width size of said receiving faces are formed in said sheet and are arrayed at an interval in the extending direction of said receiving faces.

7. The cut line forming method as set forth in claim 6,
wherein said receiving faces are formed in a helical shape on the circumference of said anvil roll.

8. The cut line forming method as set forth in claim 6,
wherein the diametrical size of said cutter roll to the edges of said cutting blades is made different from that of the receiving faces of said anvil roll.

9. The cut line forming method as set forth in claim 6,
wherein the hardness of the receiving faces of said anvil roll is lower than that of the cutting blades of said cutter roll.

10. The cut line forming method as set forth in claim 6,
wherein said sheet is made of paper, a nonwoven fabric, film, a composite of a nonwoven fabric and a film, a composite of a nonwoven fabric and a fibrous web, a composite of a film and a fibrous web, or a composite of a film, a nonwoven fabric and a fibrous web.

11. The cut line forming method as set forth in claim 10,
wherein said fibrous web is a layer of long fibers.

12. A cut line forming method comprising: using a cutter roll having cutting blades protruded on its outer circumference and an anvil roll for receiving said cutting blades; feeding a sheet into the clearance between said cutter roll and said anvil roll; and turning said rolls individually to form cut lines in said sheet,
wherein said anvil roll has receiving faces of a predetermined width formed at an interval in a circumferential direction,
wherein said cutting blades are formed to shift in said roll axis direction in accordance with the advance in the circumferential direction, so that the abutting portions of said cutting blades against said receiving faces may shift along the edges of said cutting blades at the next time when said cutting blades and said receiving faces abut against each other, and
wherein as said cutter roll and said anvil roll turn, the cut lines corresponding to the width size of said receiving faces are formed in said sheet and are arrayed at an interval in the extending direction of said cutting blades.

13. The cut line forming method as set forth in claim 12,
wherein said cutting blades are formed in a helical shape on the circumference of said cutter roll.

14. The cut line forming method as set forth in claim 12,
wherein the diametrical size of said cutter roll to the edges of said cutting blades is made different from that of the receiving faces of said anvil roll.

15. The cut line forming method as set forth in claim 12,
wherein the hardness of the receiving faces of said anvil roll is lower than that of the cutting blades of said cutter roll.

16. The cut line forming method as set forth in claim 12,
wherein said sheet is made of paper, a nonwoven fabric, a film, a composite of a nonwoven fabric and a film, a composite of a nonwoven fabric and a fibrous web, a composite of a film and a fibrous web, or a composite of a film, a nonwoven fabric and a fibrous web.

17. The cut line forming method as set forth in claim 16,
wherein said fibrous web is a layer of long fibers.
